(19) United States
(12) Patent Application Publication
(10) Pub. No.: US 2021/0216924 A1
(43) Pub. Date: Jul. 15, 2021

(54) MANAGEMENT OF SERVICE PROVIDER INFORMATION AND END USER REQUESTS FOR SERVICES

(71) Applicant: NRNR Corporation, San Ramon, CA (US)

(72) Inventor: Nagarajan Nilakantan, San Ramon, CA (US)

(21) Appl. No.: 17/143,347

(22) Filed: Jan. 7, 2021

Related U.S. Application Data
(60) Provisional application No. 62/959,061, filed on Jan. 9, 2020.

(51) Int. Cl. G06Q 10/06; G06Q 30/06

(52) U.S. Cl. CPC G06Q 10/0631; G06Q 30/0601

(57) ABSTRACT

Systems, methods, and software described herein manage service provider information for end users. In one example, a service management system obtains settings from service providers and uses the settings to provide a summary to an end user. The service management system further identifies a request for a service from the user and initiates operations to provide the service to the requesting end user, wherein the operations provide anonymity between a service provider associated with the service and the end user.

### RELATED APPLICATIONS

This application hereby claims the benefit of and priority to U.S. Provisional Patent Application No. 62/959,061, titled “MANAGEMENT OF SERVICE PROVIDER INFORMATION AND END USER REQUESTS FOR SERVICES,” filed Jan. 9, 2020, and which is hereby incorporated by reference in its entirety.

### BACKGROUND

End user devices often include online item ordering applications, ride sharing applications, service review applications, and a variety of other applications capable of providing the user with efficient access to a desired services and items. For example, an application may be used to identify restaurants with a particular type of food. Once identified, the same application may be used to book a reservation and or select food for take-out or delivery from a restaurant. However, although applications have become common place for end users to identify services from professional companies, it can be difficult for users to schedule and identify smaller providers, such as home cooks, that can provide the desired service. Similarly, it may be difficult for the smaller service providers to advertise and/or find users that are searching for their particular service or expertise.

### OVERVIEW

Provided herein are systems and methods for managing requests for service providers. In one implementation, a service management system obtains service setting from a plurality of service providers and provides a summary of at least a portion of the plurality of service providers to an end user. The service management system further identifies a request for a service from the end user and initiates operations to anonymously provide the service to the requesting user.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a system to manage service providers and user requests according to an implementation.

FIG. 2 illustrates an operation of a service management system to manage service provider settings and end user requests according to an implementation.

FIG. 3 illustrates an operational scenario of managing service provider setting and user requests to the service providers according to an implementation.

FIG. 4 illustrates a service management computing system according to an implementation.

### DETAILED DESCRIPTION

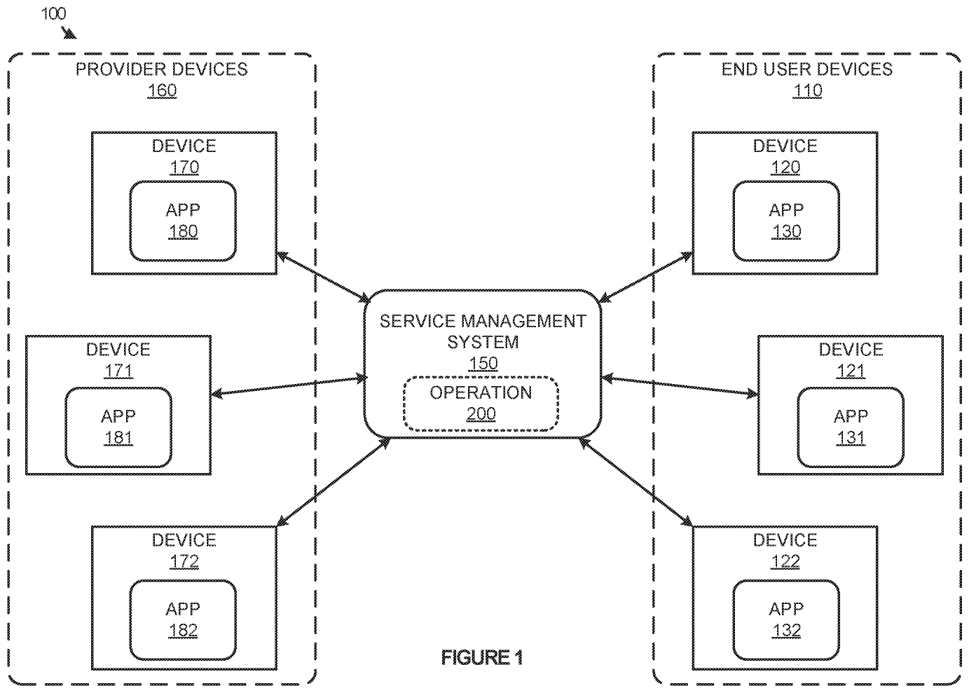

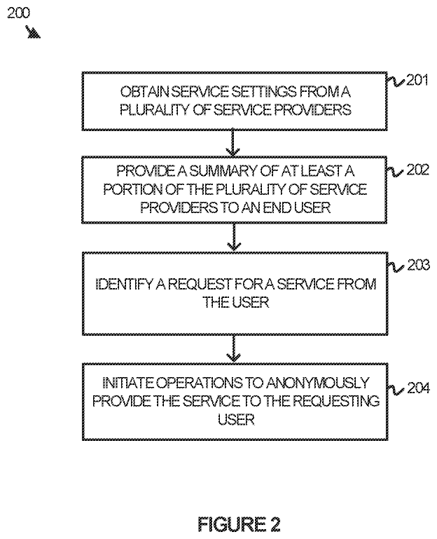

FIG. 1 illustrates a system 100 to manage service providers and user requests according to an implementation. System 100 includes end user devices 110, provider devices 160, and service management system 150. End user devices 110 further includes devices 120-122, each with an application of applications 130-132. Provider devices 160 further includes devices 170-170, each with an application of applications 180-182. Service management system 150 further includes operation 200 that is further described below with respect to FIG. 2. Although demonstrated as separate it should be understood that a service provider may also be an end user in some examples.

In operation, provider devices 160 are used by service providers to specify settings or preferences associated with their service. Once specified, the settings are communicated to service management system 150, wherein service management system 150 may store the settings for each of the service providers and provide information about the service providers to end user devices 110. As an example, a service provider associated with device 170 may use application 180 to identify the various settings of their service and provide the settings to service management system 150. Application 180 may represent a dedicated application associated with service management system 150, may represent a web browser, or may represent some other application capable of gathering preferences of the service provider.

In some implementations, the service provider may represent a home cook or a cook without a restaurant or business location. In joining the service management system, service management system 150 may provide instructions that provide compliance information (legal, company standards, etc.) for the service provider. Once the service provider completes the requirements, the service provider may generate settings for their service. These settings may include menu items, time periods for the menu items, service area or region, or some other settings. In some examples, the settings may indicate when future menu items are going to be available (e.g. a calendar), limits on quantity, or some other information. For instance, a service provider may indicate that ten servings of broccoli cheddar soup will be available on the first Sunday every month. Once the settings are specified and provided to service management system 150, service management system 150 may store the settings and use the settings to provide summaries of available services to end user device 110.

In some implementations, an end user may generate a request that contains parameters for the desired service. The parameters may include the type of service that is requested, a time period for the service, or some other parameter associated with the service. Returning to the food services example, a user may generate a request for a particular type of ethnic food and a time period for when the food will be available. Once the parameters are specified, service management system 150 may identify service providers associated with the parameters and generate a summary for the requesting user. The summary may indicate the service provider, information about the service provided (e.g., a menu or description of the service), any reviews of the service provider, or some other summary information.

For example, an end user associated with application 130 may request all Italian food that will be available on a particular Sunday. In response to the request, service management system 150 may identify all service providers that satisfy the requesting user's criteria and generate a summary of the service providers for the requesting user. In some examples, the summary may be displayed as part of application 130, wherein the display may indicate various characteristics associated with the service providers. Further, the summary may sort or generate a hierarchy of the service providers based on location of the service provider in relation to the requesting user, any reviews of the service provider, similarities between the requests of the end user and the services provided by the service provider, or some other factor. Thus, returning to the example of the Italian food request, the user may be provided with a hierarchy of service providers based on the reviews associated with the service providers.

Once the summary is provided to the end user, the end user may further select a service from one of the service providers. In response to the selection, service management system 150 may initiate processes to anonymously provide the service to the end user. In some examples, service management system 150 may determine delivery operations for the end user. These delivery operations may include delivery to the end user's home, delivery to a pickup location for the end user, or some other delivery or provisioning operation. As an example, when an end user selects a particular service, a notification may be provided to the user indicated how the service may be delivered. This may include delivery through a third party delivery driver, pickup from a location separate from the service provider, or some other delivery mechanism. In some examples, the delivery mechanism may be selected by the service provider. In other examples, the delivery mechanism for the service may be specified by service management system 150 or may be specified by the user selecting the service.

Although demonstrated in the examples herein using food preparation, it should be understood that similar operations may be applied to other services. These services may include equipment repair, personal shopping, clothing alterations, or some other similar service. In some examples, the services may correspond to services that can be provided with anonymity, such as services that can be delivered or provided through an intermediary (e.g., delivery driver).

FIG. 2 illustrates an operation 200 of a service management system to manage service provider settings and end user requests according to an implementation. The processes of operation 200 are referenced parenthetically in the paragraphs that follow with reference to elements of system 100 of FIG. 1.

As depicted, service management system 150 provides operation 200 that obtains (201) service settings from a plurality of service providers. In some implementations, the service providers may correspond to individual persons or small entities. For example, service management system 150 may be used to provide a platform that permits home cooks to make and deliver food for other members of their community. The settings that are generated by the service providers may indicate specifications about the service (e.g., a menu, a service list, ingredients, or other similar information), a schedule or calendar for when the services are available, limits to the quantities associated with the services, or some other similar information. For example, a home cook may generate setting that indicate a dish that will be available, a date that the dish will be available, and quantity limits for the dish.

After the settings are provided to service management system 150, operation 200 further provides (202) a summary of services for at least a portion of the plurality of service providers to an end user of service management system 150. In some implementations, the summary may correspond to various setting specified by the various service providers. For example, a user may provide parameters or requirements for the desired service providers. Based on the settings from the plurality of service providers, service management system 150 may select one or more of the service providers for the summary. Referring to an example in system 100, an end user at device 120 may generate a request for all service providers associated with Italian food and provide a dish on Sundays. Once the request is generated by the user, service management system 150 may identify one or more service providers from the service providers associated with provider devices 160. When identified, service management system 150 may generate a summary that indicates various settings information associated with the one or more service providers. The summary may indicate services provided (e.g., dishes available), schedules for when the services are provided, any reviews associated with the service provider, or some other information. In some instances, the service providers may be prioritized based on ratings associated with the service providers, similarities of the service providers to the request, location, or some other factor. In some examples, the summary may not provide identifiable information or may anonymize the identity of each of the service providers. The anonymization may include providing pseudonyms to the service provider, remove location information for the service provider, remove identifiable information from pictures, or provide some other operation to anonymize the identity of the service provider to the user.

Once the summary is generated for the requesting user, operation 200 identifies (203) a request for a service from the user and initiates (204) operations to anonymously provide the service to the requesting user. In some examples, when the summary is provided to the requesting user, the user application may permit the user to select a service from one of the service providers. For instance, when the user requests a summary for service providers associated with a particular type of food, service management system 150 may provide the user with a list of one or more service providers. From the list, the user may select a service provider, which initiates an operation to anonymously provide the service to the end user.

In some implementations, when the user selects a service, a notification may be provided to the service provider indicating that a user has selected and/or paid for the service. For example, a service provider may produce a food item that can be supplied to ten end users on a Sunday. When a user selects the food item, service management system 150 may update a local database indicating that one less food item remains available. Additionally, service management system 150 may provide a notification to the service provider indicating the quantity of users that have selected the food item. In some instances, the ability for users to select a service from service management system 150 may be limited to a period prior to the service being provided. For example, a setting may indicate that a service provider requires two days of notice prior to providing the service.

After a service is selected, service management system 150 may further provide the operations to anonymously provide the interaction between the service provider and the end user. This may include providing transportation of the end good to the requesting end user, providing transportation of an item from the end user to the service provider, providing a pickup/drop-off point for goods, or providing some other operation. For example, when the service provider indicates that ten food items will be made available and are selected by ten end users, service management system 150 may provide operations to orchestrate the delivery of the food items to the requesting user. These operations may include scheduling the pick-up of food items, scheduling delivery of the food items, providing a list of available delivery providers for the food, or some other operation to facilitate the anonymous delivery of the food items between the provider and the end users.

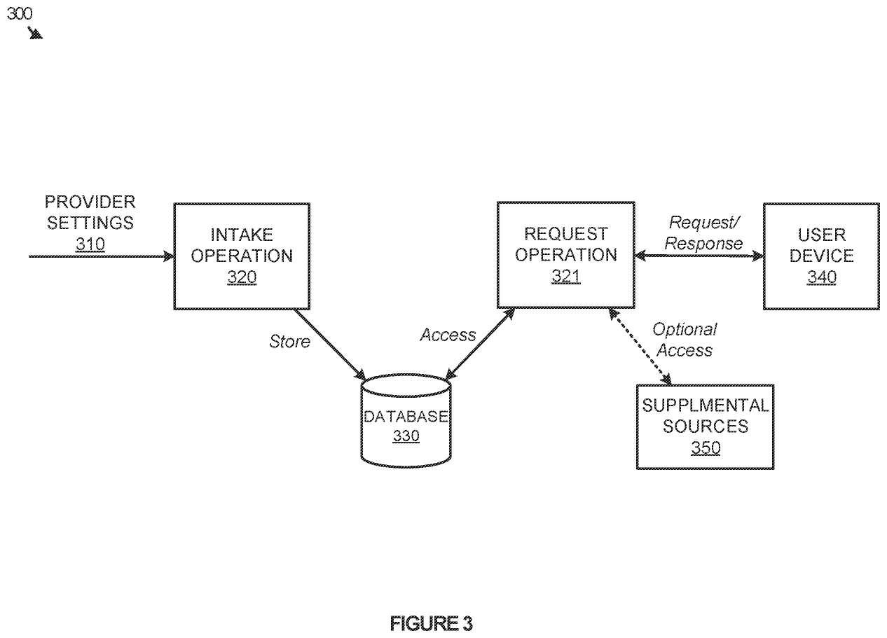

FIG. 3 illustrates an operational scenario 300 of managing service provider setting and user requests to the service providers according to an implementation. Operational scenario 300 includes provider settings 310, operations 320-321, database 330, user device 340, and supplemental sources 350. Operations 320-321 are representative of the operations that can be provided a service management system, such as service management system 150 of FIG. 1.

In operation, service provider may generate provider settings 310, wherein provider settings 310 may indicate services provided, schedules for the services, quantity limits, or some other information. Once obtained, intake operation 320 stores provider settings 310 in database 330 with the settings for other service providers. Database 330 may comprise one or more data structures, such as tables, linked lists, trees, or some other data structure.

After storing the provider settings, request operation 321 further obtains a request from user device 340. In some implementations the request may include specifications or preferences for the service requested by the user. These specifications may include the type of service requested (e.g., type of food), a time period that the service is requested, a geographic region associated with the user, or some other preference associated with the user. In response to the request, request operation 321 access database 330 and identifies service providers that satisfy the preferences of the user based on the settings specified by the service providers. As an example, if user device 340 generated a request for service providers associated with Indian food, request operation 321 may access database 330 to identify any service providers that satisfy the preferences of the end user.

Once accessed, request operation 321 may generate a summary of the service providers, or settings of the service providers, and provide the summary to user device 340. In some examples, the summary may list the various service providers (in some examples with anonymity operations, such as hiding the service provider name, address, images of the service provider, generating a pseudonym for the or some other operation), may list reviews of the service providers, may list cost, may list location or delivery information, or may provide some other information. From the summary, the user may interact with user device 340 to select a service from one of the service providers. For example, user device 340 may provide a display listing various services from various service providers. The user may then select a service in the list that is identified by request operation 321. In response to the selection, request operation 321 will initiate operations to implement the desired request.

In some examples, to initiate the desired operations, request operation 321 may maintain accommodation information to fulfill the various services while maintaining anonymity between the service provider and the user requesting the service. For example, request operation 321 may identify transportation of goods, storage locations for goods, scheduling, or some other information to fulfill the required service. As an example, a service provider may generate a food item that is selected by multiple end users. When the food item is to be delivered, request operation 321 may identify available delivery options, select an option or give suggestions for the service provider to deliver the required food item. In some examples, the service management system may use its own delivery vehicles and or drop of locations for items associated with the service provider. In other examples, the service management system may interact with one or more other delivery services to provide the transportation of the items to the required locations.

In some implementations, the service management system may work to provide multiple services or to be integrated with other existing services. These services may include housing rentals, ride sharing, or other similar applications and/or services. In at least one implementation, a housing rental service may include information about available services and a user may select the additional services using the service management system. For example, a rental user may select one or more food items to be delivered to the rental. These food items may be sourced from other persons in the geographic region or may be sourced from the owner of the rental in some examples.

In one implementation, the service management system may be incapable of identifying a service provider that satisfies the request from user device 340. In response to determining that a service provider is incapable of providing the requested information, request operation 321 may be used to identify service providers that provide similar services to the requested services from user device 340, wherein the similar services may be determined based on field, geographic region, or some other factor. In some implementations, request operation 321 may consult supplemental sources 350 to determine if other platforms may be capable of supporting the user request. Supplemental sources 350 may comprise other services or applications, search engines, or some other supplemental source. For example, if a service provider associated with the service management system is incapable of supporting a request for a food item, the service management system may consult with supplemental sources 350 (e.g., restaurant services) to provide other recommendations to the requesting user. Here, when the recommendations are provided, the service provider from the supplemental sources may be known to the user rather than provided with anonymity (e.g., hidden names, locations, and the like) that is provided when using the service provider system described herein.

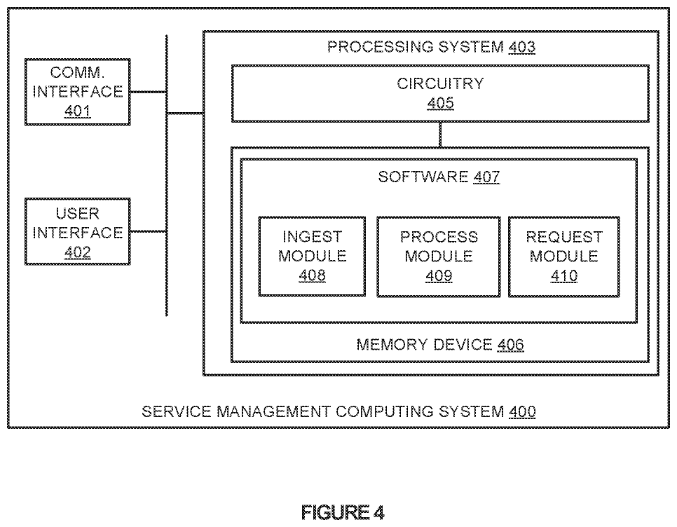

FIG. 4 illustrates a service management computing system according to an implementation. Computing system 400 is representative of any computing system or systems with which the various operational architectures, processes, scenarios, and sequences disclosed herein for an event summary service may be implemented. Computing system 400 is an example of service management system 150 of FIG. 1, although other examples may exist. Computing system 400 comprises communication interface 401, user interface 402, and processing system 403. Processing system 403 is linked to communication interface 401 and user interface 402. Processing system 403 includes processing circuitry 405 and memory device 406 that stores operating software 407. Computing system 400 may include other well-known components such as a battery and enclosure that are not shown for clarity.

Communication interface 401 comprises components that communicate over communication links, such as network cards, ports, radio frequency (RF), processing circuitry and software, or some other communication devices. Communication interface 401 may be configured to communicate over metallic, wireless, or optical links. Communication interface 401 may be configured to use Time Division Multiplex (TDM), Internet Protocol (IP), Ethernet, optical networking, wireless protocols, communication signaling, or some other communication format—including combinations thereof. In some implementations, communication interface 401 may be used to communicate with end user and provider devices, wherein the devices may provide settings for the service providers and requests from the end users.

User interface 402 comprises components that interact with a user to receive user inputs and to present media and/or information. User interface 402 may include a speaker, microphone, buttons, lights, display screen, touch screen, touch pad, scroll wheel, communication port, or some other user input/output apparatus—including combinations thereof. User interface 402 may be omitted in some examples.

Processing circuitry 405 comprises microprocessor and other circuitry that retrieves and executes operating software 407 from memory device 406. Memory device 406 may include volatile and nonvolatile, removable and non-removable media implemented in any method or technology for storage of information, such as computer readable instructions, data structures, program modules, or other data. Memory device 406 may be implemented as a single storage device but may also be implemented across multiple storage devices or sub-systems. Memory device 406 may comprise additional elements, such as a controller to read operating software 407. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 405 is typically mounted on a circuit board that may also hold memory device 406 and portions of communication interface 401 and user interface 402. Operating software 407 comprises computer programs, firmware, or some other form of machine-readable program instructions. Operating software 407 includes ingest module 408, process module 409, and request module 410, although any number of software modules may provide the same operation. Operating software 407 may further include an operating system, utilities, drivers, network interfaces, applications, or some other type of software. When executed by processing circuitry 405, operating software 407 directs processing system 403 to operate computing system 400 as described herein.

In one implementation, ingest module 408 directs processing system 403 to obtain settings associated with service providers, wherein the settings provide information about what services are provided by each of the service providers. Once the settings are obtained, process module 409 provides a summary to a requesting user, wherein the summary includes at least a subset of the settings information obtained from the service providers. In some examples, the summary may be provided in response to a request by the end user. The request may indicate requirements or preferences for the service requested by the end user and process module 409 may be used to determine the service providers that are capable of satisfying the request. The summary may indicate feedback or ratings associated with service providers, details about the service, scheduling information for the service, or some other information. Additionally, in some examples, process module 409 may be used to provide a ranking information for the various service providers and services, wherein the rankings may be based on feedback, the similarities to the requested attributes from the end user, or some other factor.

Once a summary is provided to the end user, the end user may select a service from the available services. For example, from the list of available services (and service providers), the end user may select a service and have the information provided to computing system 400. Request module 410 directs processing system 403 to receive the request and initiate operations to provide the requested service.

In at least one implementation, request module 410 may be used to provide anonymity between the requesting end user and the service provider. The anonymity may correspond to names, locations, or some other information related to the end user and/or the service provider. In some examples, to support the operation, request module 410 may identify the request from the end user and initiate operations to transport objects associated with the service between the service provider and the end user. For example, a service provider may provide food items to multiple end users and may indicate a time for when the food items will be ready for the end users. When the completion time arrives, request module 410 may identify a service capable of providing or transporting the food items to their destination end users. In some examples, computing system 400 may contact the transportation services directly. In other examples, computing system 400 may provide instructions to the service provider and the service provider may initiate operations to transport the items to the end users.

In some examples, the service provider items may be provided directly to the end user. In other examples, the service providers and end users may use drop off points, wherein the service provider may drop the requested item at a set location, and the user may pick-up the item from the location.

Returning to the elements of FIG. 1, service management system 150 comprise communication interfaces and network interfaces, processing systems, computer systems, microprocessors, storage systems, storage media, or some other processing devices or software systems, and can be distributed among multiple devices. Service management system 150 may include software such as an operating system, logs, databases, utilities, drivers, networking software, and other software stored on a computer-readable medium.

Devices 120-122 and 170-172 may each comprise smartphones, smart speakers, computers, tablets, or some other similar computing device. Devices 120-122 and 170-172 may each comprise communication interfaces and network interfaces, processing systems, computer systems, microprocessors, storage systems, storage media, or some other processing devices or software systems.

Communication between devices 120-122 and 170-172 and service management system 150. Communication between the between devices 120-122 and 170-172 and service management system 150 may use metal, glass, optical, air, space, or some other material as the transport media. Communication between devices 120-122 and 170-172 and service management system 150 may use various communication protocols, such as Time Division Multiplex (TDM), asynchronous transfer mode (ATM), Internet Protocol (IP), Ethernet, synchronous optical networking (SONET), hybrid fiber-coax (HFC), circuit-switched, communication signaling, wireless communications, or some other communication format, including combinations, improvements, or variations thereof. Communications between devices 120-122 and 170-172 and service management system 150 may be a direct link or can include intermediate networks, systems, or devices, and can include a logical network link transported over multiple physical links.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
obtaining service settings from a plurality of service providers;
providing, for display, a summary of services for at least a portion of the plurality of service providers to an end user, wherein the summary anonymizes the identities of the plurality of service providers;
identifying a request for a service from a service provider of the plurality of service providers from the user; and
initiating operations to anonymously provide the service to the requesting end user.

2. The method of claim 1, wherein the service settings for each service provider of the plurality of service providers comprise a menu for one or more services available from the service provider.

3. The method of claim 2, wherein the service settings for each service provider of the plurality of service providers further comprise a schedule for when the one or more services will be available.

4. The method of claim 3, wherein the service settings for each service provider of the plurality of service providers further comprise quantity limits associated with the one or more services.

5. The method of claim 3 further comprising:
receiving preferences from the end user;
identifying one or more service providers in the plurality of service providers that satisfy the preferences; and
wherein providing, for display, the summary of services for at least the portion of the plurality of service providers to the end user comprises providing, for display, a list of the one or more service providers.

6. The method of claim 5, wherein the preferences comprise a type of service and a time period for the service.

7. The method of claim 5 further comprising prioritizing the list based on ratings associated with the one or more service providers.

8. The method of claim 2, wherein the service settings for each service provider of the plurality of service providers further comprises a geographic region for the service provider.

9. The method of claim 1, wherein initiating the operations to anonymously provide the service to the requesting end user comprises providing a pickup/drop-off point for the service or scheduling delivery of the service.

10. The method of claim 1, wherein the summary of services does not indicate names or locations of the plurality of service providers.

11. A computing apparatus comprising:
a storage system;
a processing system operatively coupled to the storage system; and
program instructions stored on the storage system that, when executed by the processing system, direct the computing apparatus to:
obtain service settings from a plurality of service providers;
provide, for display, a summary of services for at least a portion of the plurality of service providers to an end user, wherein the summary anonymizes the identities of the plurality of service providers;
identify a request for a service from a service provider of the plurality of service providers from the user; and
initiate operations to anonymously provide the service to the requesting end user.

12. The computing apparatus of claim 11, wherein the service settings for each service provider of the plurality of service providers comprise a menu for one or more services available from the service provider.

13. The computing apparatus of claim 12, wherein the service settings for each service provider of the plurality of service providers further comprise a schedule for when the one or more services will be available.

14. The computing apparatus of claim 13, wherein the service settings for each service provider of the plurality of service providers further comprise quantity limits associated with the one or more services.

15. The computing apparatus of claim 13, wherein the program instructions further direct the computing apparatus to:
receive preferences from the end user;
identify one or more service providers in the plurality of service providers that satisfy the preferences; and
wherein providing, for display, the summary of services for at least the portion of the plurality of service providers to the end user comprises providing, for display, a list of the one or more service providers.

16. The computing apparatus of claim 15, wherein the preferences comprise a type of service and a time period for the service.

17. The computing apparatus of claim 15, wherein the program instructions further direct the computing apparatus to prioritize the list based on ratings associated with the one or more service providers.

18. The computing apparatus of claim 12, wherein the service settings for each service provider of the plurality of service providers further comprises a geographic region for the service provider.

19. The computing apparatus of claim 11, wherein initiating the operations to anonymously provide the service to the requesting end user comprises providing a pickup/drop-off point for the service or scheduling delivery of the service.

20. The computing apparatus of claim 11, wherein the summary of services does not indicate names or locations of the plurality of service providers.
